(19) United States
(12) Patent Application Publication
(10) Pub. No.: US 2008/0233483 A1
(43) Pub. Date: Sep. 25, 2008

(54) Layer having shielded fibers; and galvanic cell

(75) Inventors: Peter Kritzer, Forst (DE); Holger Schilling, Heitersheim (DE)

Correspondence Address: Davidson, Davidson & Kappel, LLC, 485 7th Avenue, 14th Floor, New York, NY, 10018, US

(73) Assignee: Carl Freudenberg KG, Weinheim (DE)

(21) Appl. No.: 12/009,720

(22) Filed: Jan. 22, 2008

(30) Foreign Application Priority Data
Jan. 23, 2007 (DE) DE 102007004257.6

(51) Int. Cl. H01M 2/16

(52) U.S. Cl. 429/249

(57) ABSTRACT

A layer, in particular for use as a separator in galvanic cells, including fibers having at least one first substance which renders possible the chemical and/or physical binding of ammonia or ammonia compounds. A galvanic cell having a low self-discharging rate over its entire life cycle having a layer wherein a first substance is present in volumetric regions of the fibers whose surface areas are at least partially covered by a second substance.

This applications claims the benefit of German Patent Application No. 102007004257.6 filed Jan. 23, 2007 and hereby incorporated by reference herein.

The present invention relates to a layer which may be used as a separator in galvanic cells, including fibers having at least one first substance which renders possible the chemical and/or physical binding of ammonia or ammonia compounds. The present invention also relates to a galvanic cell.

### BACKGROUND INFORMATION

Alkaline batteries or cells require separator materials having special properties. These properties include resistance to the electrolyte, resistance to oxidation, high mechanical stability, a small thickness, low resistance to the passage of ions, high resistance to the passage of electrons, capacity to retain solid particles released from the electrodes, permanent wettability by the electrolyte, and high storage capacity for the electrolytic fluid.

Nickel-metal-hydride or nickel-cadmium storage batteries exhibit an accelerated self-discharging. The charge transport is effected by ions or molecules which are transported in the electrolyte from the negative cadmium or metal-hydride electrode to the positive nickel-oxide electrode, where they are electrochemically converted. The cell self-discharges slowly, even in the quiescent state.

Nitrogen compounds have been discussed as a mechanism of this unwanted self-discharging. By undergoing reduction at the negative electrode and oxidation at the positive electrode in what is generally known as a “shuttle mechanism,” they are responsible for the self-discharging.

The layers of the type described diminish the self-discharging in that they chemically and/or physically bind ammonia and thereby slow the discharging.

Nevertheless, the galvanic cells of the type described are characterized by such a rapid self-discharging that they are unsuited for many application purposes, such as for use in hybrid vehicles, for example. Moreover, the galvanic cells of the type described exhibit an inadequate long-term stability with respect to self-discharging, which can be explained, inter alia, by the chemical or electrochemical degradation of the separator.

### SUMMARY OF THE INVENTION

An object of the present invention is, therefore, to devise a galvanic cell that is characterized by a low self-discharging over its entire life cycle.

The present invention provides a layer, in particular for use as a separator in galvanic cells, comprising fibers having at least one first substance which renders possible the chemical and/or physical binding of ammonia or ammonia compounds, wherein the first substance is present in volumetric regions of the fibers whose surface areas are at least partially covered by a second substance.

Surprisingly, it turns out that the layer according to the present invention exhibits an enhanced resistance to chemical or electrochemical degradation. This is especially beneficial when the layer is used in a galvanic cell in hybrid vehicles or other applications requiring a long service life.

It has been discovered in accordance with the present invention that the enhanced resistance is achieved in that the first substance is shielded by a second substance. Surprisingly, this shielding prolongs the period of action of the self-discharging effect in a galvanic cell in which the layer according to the present invention is used.

Surprisingly, the covering does not block the binding of ammonia, but instead acts additionally as antiaging protection for the clad volumetric regions.

While the ammonia-binding capacity of a layer in accordance with the related art clearly diminishes following storage in hot potassium hydroxide solution (simulation of a long-term use in a battery) (the binding capacity decreases by approximately 50% and more), the fibers in accordance with the present invention virtually do not exhibit such a functional degradation.

Surprising above all is the fact that the binding of ammonia is still effective when the functional volumetric region is completely surrounded by a non-functional cladding.

Accordingly, the objective stated at the outset can be achieved.

The volumetric regions may be formed as cores and the fibers as core-sheath fibers. Core-sheath fibers are relatively simple to produce. Moreover, the embodiment as a core-sheath fiber allows the first substance to be virtually completely shielded by the second substance. In this embodiment, the first substance is located in the core and the second substance in the sheath. In particular, the core may be made entirely of the first substance, and the sheath entirely of the second substance.

The layer may be characterized by an at least 80% degree of coverage of the volumetric regions. In this context, the sheath of a core-sheath fiber may cover 80% of the core. On the one hand, this specific embodiment allows the ammonia compounds, respectively the ammonia in the electrolytic fluid, to interact sufficiently with the first substance and, on the other hand, for the first substance to be shielded. By employing the degree of coverage indicated, the advantage is derived, on the one hand, that the first substance is not able to be chemically attacked (by hydrolysis or oxidation) and, on the other hand, the bound ammonia contained therein is not or is only very slowly able to be liberated again.

The layer may have an at least 30% by weight proportion of the previously described fibers. This specific embodiment has proven to be beneficial with respect to imparting adequate mechanical stability to the layer, on the one hand, and effectively suppressing the self-discharging of a galvanic cell, on the other hand.

At least one first substance may include a first polymer, and the second substance of a second polymer that differs from the first. Given these facts, it is conceivable for polyethylene, polypropylene, higher aliphatic polyolefins, polystyrene or copolymers of these polymers to be used as polymers. In addition, polymers may be used which, as is generally known, are resistant to the conditions prevailing in alkaline batteries.

Since the first polymer differs from the second polymer, it allows a boundary layer to form between the polymers which inhibits the migration of the functional groups of the first inner polymer to the fiber surface. Inhibiting the migration in this manner has the effect of reducing the accumulation of ions or molecules, which, in terms of their accumulation behavior, are chemically similar to the ammonia and, therefore, would compete with the binding of ammonia. This suppresses the occupancy of the functional groups, making them available for a long period of time for binding ammonia, respectively ammonia compounds.

The first or the first and second polymer may include polymers that are formed by copolymerization. In this context, it is conceivable that either the inner polymer is formed by copolymerization or, however, that both polymers are formed by copolymerization. In any case, however, the first polymer differs from the second polymer. A copolymerization process produces a material having an especially homogeneous and stable internal structure. This allows an especially advantageous distribution of chemically active molecules in a volume.

The first or the first and second polymer may include polymers that are formed by grafting. In this case as well, the first polymer always differs from the second polymer. Given these facts, the polymers present in a melt or solution or in a dispersion or in a ground state may, in particular, be conceivably grafted with acrylic acid or other unsaturated acids or acid derivatives and then subsequently spun into fibers.

Alternatively, fibers already having a core that has been modified may be grafted with acrylic acid in a dispersion following the spinning process, whereby a modified outer film would be formed. The fibers may be subsequently further processed in downstream processes into a nonwoven fabric, without undergoing any further chemical modification.

The first or the first and second polymer may include polymers that are formed by reactive extrusion. In this case as well, the first polymer always differs from the second. In the case of the reactive extrusion, the polymers may be functionalized to exhibit functional groups in the molecule or form the same in the alkaline electrolyte that are capable of binding ammonia or ammonia compounds from the alkaline solutions. In this context, the polymers may contain functional groups that are active as Lewis acids in the alkaline medium. This specific embodiment allows the functional groups to be able to bind ammonia or ammonia compounds in the alkaline solution.

The first and/or the second polymer may include polyolefins. In this case as well, the first polymer always differs from the second. Polyolefins exhibit excellent resistance to chemical attack by highly alkaline electrolytes and to oxidation in the chemical environment of the galvanic cells. Therefore, polyolefins constitute materials which may be used for manufacturing a very stable layer.

The first or the first and the second polymer may include polyolefins which are modified by unsaturated organic acids and/or acid derivatives. This modification enhances the ammonia-binding capacity of the layer. In this context, the first polymer may be formed from polyolefin that is modified by reactive extrusion or by grafting acrylic acid onto the same. The use of acrylic acid substantially enhances the ammonia-binding capacity.

The first polymer may include a polyolefin that is sulfonated. The sulfonation of a polyolefin enhances its ammonia-binding capacity.

A boundary layer may be formed between the first polymer and the second polymer that differs from the first. A migration of the functional groups of the core polymer to the fiber surface and the loss of functionality associated therewith caused by the accumulation of molecules competing with ammonia and the chemical or electrochemical degradation, is inhibited by the boundary layer disposed between the two different polymers.

The cladding polymer may be present in a partially amorphous state. In this connection, the amorphous regions form microchannels. An ammonia molecule is able to diffuse through these microchannels, attach itself to the first inner polymer and be bound thereto. The potassium or hydroxide ions surrounded by a hydration sheath that are largely present in the electrolyte of the galvanic cells, are considerably larger than the ammonia molecule. These larger ions are not able to migrate through the microchannels and thus do not displace or replace the ammonia bound by the first polymer.

In a battery, the layer may have an ammonia-binding capacity of at least 0.1 mmol/g, preferably of at least 0.25 mmol/g. These selected values represent characteristic values at which the discharge duration of a galvanic cell is clearly prolonged.

Following an eight-day storage in a 30% aqueous solution of potassium hydroxide having a temperature of 85° C., the ammonia-binding capacity of the layer may be at least 50% of the initial value. In this case, the initial value of the ammonia-binding capacity is 0.1 mmol/g. A layer of this kind is especially suited for use as a separator in batteries for long-term applications under real-world conditions.

Besides the fibers described here having first and second substances, other second fibers that differ therefrom and that are hydrolytically stable in concentrated alkaline solution, may be provided. The mechanical stability of the layer may be enhanced by the provision of these second fibers.

To achieve good wettability, the layer may have hydrophilic properties, in particular hydrophilic surfaces. These may be obtained in a fluorination process, a plasma treatment or in a sulfonation process. The layer may be grafted with polar, unsaturated organic substances. In addition, a wetting agent may be applied to the layer. Commercial wetting agents are readily available.

The layer may have a substance weight of 15-300 g/m², preferably of 25-150 g/m². This allows the layer to have an adequate fluid absorbing capacity, and, at the same time, pores small enough to virtually prevent conductive particles from causing electric breakdown.

The layer may have a thickness of 20 to 400 μm, preferably of 40 to 250 μm. That range makes it feasible to produce a galvanic cell having practical internal and external dimensions. A separator may be composed of two or more of the layers described in the present invention. Multilayer separators are able to better compensate for defects in the layers than are single-layer separators. This makes the multilayer separators suited for long-term applications. Moreover, the various layers may differ from one another in substance weight, respectively thickness, the separator featuring a gradient structure in terms of thickness or substance weight.

The layer may include nonwoven fabric. A multitude of processes may be employed to manufacture nonwoven fabrics inexpensively. Moreover, by using nonwoven fabrics manufactured in a static process, an excellent homogeneity of the layer is allowed and the occurrence of through holes (“pin holes”) is effectively prevented.

The nonwoven fabric may conceivably be manufactured using a wet-laid technology. This type of manufacturing allows highly homogeneous nonwoven fabrics.

The nonwoven fabric may also be conceivably manufactured using a dry-laid nonwoven technology. When such a technology is used, no media act on the nonwoven material that would negatively affect the stability thereof.

The nonwoven fabric may also be fabricated using a spunbond or meltblown technology which permits manufacture of bicomponents. This type of fabrication allows very thin fibers to be manufactured and, therefore, nonwoven fabrics having a high specific surface area.

The present invention also provides a galvanic cell comprising a casing, the casing at least partially accommodating at least one positive and one negative electrode; a material that permits the transport of charge carriers; a separator separating the electrodes, wherein the separator includes a layer, in accordance with the layer described above.

The teaching of the present invention may be advantageously embodied and further refined in different ways.

In conjunction with the explanation of the preferred exemplary embodiments of the present invention which makes reference to the tables and the drawing, generally preferred embodiments and refinements of the teaching are also elucidated.

### BRIEF DESCRIPTION OF THE DRAWING

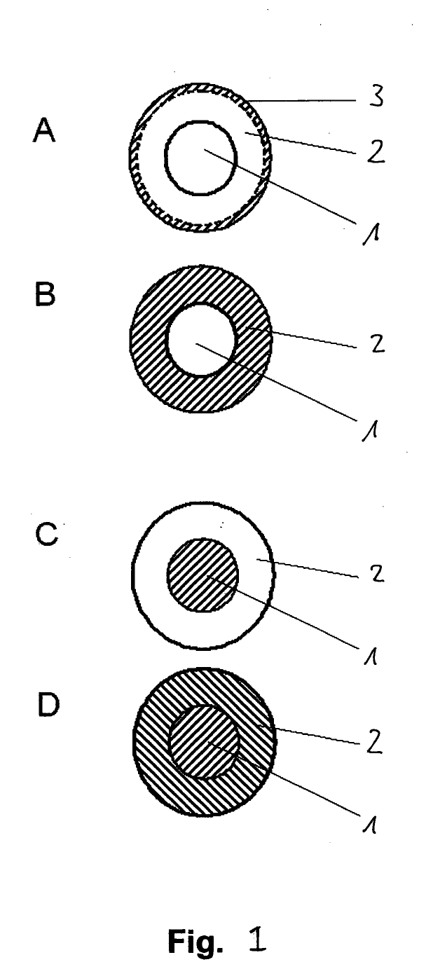

In the drawing, FIG. 1 shows a schematic representation of core-sheath fibers.

### DETAILED DESCRIPTION

FIG. 1 shows core-sheath fiber types, A and B, in accordance with the related art and, core-sheath fibers, C and D, in accordance with the present invention.

Fiber types A and B, as shown in FIG. 1, are already known from the related art. In core 1, fiber type A has a polymer that does not exhibit any ammonia-binding capacity. The polymer of sheath 2 likewise does not exhibit any ammonia-binding capacity. Merely surface 3 of sheath 2 is functionalized in a way that allows the fibers in the region of the surface to exhibit an ammonia-binding capacity. In this region, the second polymer of sheath 2 is functionalized to exhibit an ammonia-binding capacity. In this connection, the related art includes the processes of sulfonation or of grafting of unsaturated substances, such as acrylic acid.

Fiber type B has a first polymer in core 1 that does not exhibit any ammonia-binding capacity. The second polymer forming sheath 2 is functionalized to exhibit an ammonia-binding capacity.

Fiber types C and D, as shown in FIG. 1, show layers according to the present invention.

In fiber type C, merely the polymer of core 1 is functionalized to exhibit an ammonia-binding capacity. It is clad by a second polymer that does not exhibit any ammonia-binding capacity.

In core 1, fiber type D has a first polymer that is functionalized to exhibit an ammonia-binding capacity. The second polymer of sheath 2 which differs from the first polymer of core 1 is likewise functionalized. The functionalization of the second polymer likewise imparts an ammonia-binding capacity thereto.

Another embodiment of fiber type C or D may include a functionalized polymer in the core and a non-functionalized polymer in the sheath, wherein the polymer in the sheath may be subsequently surface-functionalized, as described with regard to fiber type B.

To determine the ammonia-binding capacity of the “Exemplary Embodiments” described below, the following process is employed:

Approximately 2 g of the starting polymer provided as fibrous or separator material were stored for three days at 40° C. in 120 ml of an 8 molar solution of potassium hydroxide (KOH) with 5 ml of 0.3 molar ammonia (NH₃) being added thereto. Two blank tests were simultaneously prepared without any starting polymer.

Following storage, filter paper was used to take up and remove any oily deposits existing on the surface. From the original 125 ml of the batch, a 100-ml aliquot was taken, and the ammonia was removed by steam distillation and collected in 150 ml of distilled water to which 10 ml of 0.1 molar hydrochloric acid (HCL) and a few drops of methyl red indicator had been added. The acid was subsequently back-titrated with 0.1 normal sodium hydroxide solution (NaOH).

The long-term stability of the layer was determined by storing the fibrous or separator material in a 30% aqueous solution of potassium hydroxide at a temperature of 85° C. for a time period of eight days. Following removal of the fibrous or separator material and washing with distilled water until reaching neutrality, the ammonia-binding capacity was determined once again, as described at the outset.

The degradation of the ammonia-binding capacity was computed from the quotient of the binding capacity subsequently to storage and that prior to storage.

### EXEMPLARY EMBODIMENTS

A) Ammonia-binding polyolefin fibers were produced by way of example, using the following processes:

A1-1: Use of a core-sheath fiber having a core of acrylic acid-grafted polypropylene and a sheath of non-functionalized polyethylene.

As a core polymer, a polypropylene was used that had been modified by chemically grafting an approximately 5.5% acrylic acid (AS) onto the same. The sheath polymer used was a commercial polyethylene manufactured by DOW®. The core-sheath ratio was 50:50. A titer of approximately 1.7 dtex was obtained for the fibers. The ammonia-binding capacity of the fibers was 0.39 mmol NH₃ per g of fibrous material.

A1-2: Use of a core-sheath fiber having a core of an acrylic acid-grafted polypropylene and a sheath of acrylic acid-grafted polyethylene.

As a core polymer, a polypropylene was used that had been modified by chemically grafting an approximately 5.5% acrylic acid (AS) onto the same. As a sheath polymer, a modified polyethylene was used that had likewise been modified by chemically grafting an approximately 6% acrylic acid (AS) onto the same. The core-sheath ratio was 50:50. A titer of approximately 2.0 dtex was obtained for the fibers. The ammonia-binding capacity of the fibers was 0.55 mmol NH₃ per g of fibrous material.

Comparative example A2: Use of a core-sheath fiber having a “core” of polypropylene and a “sheath” of an acrylic acid-grafted polyethylene.

The core-sheath ratio was 50:50. A titer of approximately 1.7 dtex was obtained for the fibers. The ammonia-binding capacity of the fibers was 0.38 mmol NH₃ per g of fibrous material. The fiber produced in this manner is described in the German Patent Application DE 102005005852 A1.

B) Nonwoven fabrics that were produced from the previously described fibers:

B1-1: The modified core-sheath fibers mentioned under A1-1 were dispersed and wet-laid in a 100% proportion to form a nonwoven. The nonwoven formed having a substance weight of 60 g/m² was subsequently thermally bonded at 125° C. and calendered to a thickness of 180 μm. The measured ammonia-binding capacity was 0.38 mmol NH₃ per g of nonwoven fabric.

B1-2: 70% of the core-sheath fibers were dispersed in accordance with A1-1 with 30% unblended polypropylene fibers having a titer of 0.8 dtex (manufactured by Daiwabo®, Japan), and a nonwoven was wet-laid. The nonwoven formed having a substance weight of 60 g/m² was subsequently thermally bonded at 125° C. and calendered to a thickness of 140 μm. The measured ammonia-binding capacity was 0.28 mmol NH₃ per g of nonwoven fabric.

B1-3: 85% of the core-sheath fibers were dispersed in accordance with A1-1 with 15% split fibers (polymers PP/EVOH; 32 segments) having a titer of 3.3 dtex (manufactured by Daiwabo®, Japan), and a nonwoven was wet-laid. The split fibers mentioned above were able to be split by introducing high mechanical energy during the dispersion. The nonwoven formed having a substance weight of 60 g/m² was subsequently thermally bonded at 125° C. and calendered to a thickness of 140 μm. The measured ammonia-binding capacity was 0.33 mmol NH₃ per g of nonwoven fabric.

B1-4: This exemplary embodiment describes a layer that is 100% composed of the fibers described under A1-2. The fibers were dispersed, and a nonwoven was wet-laid therefrom. The nonwoven formed having a substance weight of 60 g/m² was subsequently thermally bonded at 127° C. and calendered to a thickness of 180 μm. The measured ammonia-binding capacity was 0.53 mmol NH₃ per g of nonwoven fabric.

B1-5: The fibers described under A1-1 were processed into a dry-laid nonwoven. The nonwoven formed having a substance weight of 60 g/m² was subsequently thermally bonded at 125° C. and calendered to a thickness of 180 μm. The measured ammonia-binding capacity was 0.36 mmol NH₃ per g of nonwoven fabric. The fibers used in the process were adapted in terms of their morphology to the dry-laid process. An increased staple length was selected to produce a crimping effect.

### COMPARATIVE EXAMPLES

### Blank Tests

B2-1: One utilized the commercially available product FS 2226 (substance weight of 60 g/m²; thickness of 180 μm) made of non-functionalized (not in accordance with the present invention) polyolefin fibers. The measured ammonia-binding capacity was 0 mmol NH₃ per g of layer material.

B2-2: A layer was used made of fibers functionalized in the sheath, as described in German Patent Application DE 102005005852 A1 (comparative example A2). The measured ammonia-binding capacity was 0.31 mmol NH₃ per g of layer material.

B2-3: One used the commercially available nonwoven fabric 700/77 of the firm Scimat, UK, that had been surface-functionalized by UV-induced grafting of acrylic acid. The measured ammonia-binding capacity was 0.29 mmol NH₃ per g of nonwoven fabric.

B2-4: One used the commercially available nonwoven fabric FV 4365 of the firm Japan Vilene Co., Japan, that had been surface-functionalized by sulfonation using oleum. The measured ammonia-binding capacity was 0.32 mmol NH₃ per g of nonwoven fabric.

B2-5: One used the commercially available nonwoven fabric PZ P64 L of the firm Daiwabo, Japan, that had been surface-functionalized by sulfonation using gaseous S03. The measured ammonia-binding capacity was 0.15 mmol NH₃ per g of nonwoven fabric.

In the following, Table 1 shows an overview of the ammonia-binding capacity of the previously described exemplary embodiments and comparative examples (blank tests).

The ammonia-binding capacity is given in mmol of ammonia per gram of layer material.

TABLE 1

| | | | Ammonia | Remaining |
|---|---|---|---|---|
| | | | Binding | Ammonia |
| | | Ammonia | Capacity | Binding |
| | | Binding | Following | Capacity |
| Exemplary | | Capacity | Storage | Following |
| Embodiment | Functionalization | [mmol NH₃/g] | [mmol NH₃/g] | Storage [%] |
| A1-1 | internally | 0.39 | 0.36 | 92 |
| | functionalized fiber | | | |
| A1-2 | internally and | 0.55 | 0.42 | 76 |
| | externally | | | |
| | functionalized fiber | | | |
| A2 | externally | 0.38 | 0.15 | 40 |
| | functionalized fiber | | | |
| B1-1 | nonwoven fabric | 0.38 | 0.32 | 84 |
| | having internally | | | |
| | functionalized fiber | | | |
| B1-2 | nonwoven fabric | 0.28 | 0.22 | 79 |
| | having internally | | | |
| | functionalized fiber | | | |
| B1-3 | nonwoven fabric | 0.33 | 0.26 | 79 |
| | having internally | | | |
| | functionalized fiber | | | |
| B1-4 | nonwoven fabric | 0.53 | 0.41 | 77 |
| | having internally and | | | |
| | externally | | | |
| | functionalized fiber | | | |
| B1-5 | analogous to B1-1, | 0.36 | 0.29 | 81 |
| | however dry-laid | | | |
| | nonwoven | | | |
| B2-1 | nonwoven fabric | <0.01 | <0.01 | no data |
| | having non- | | | |
| | functionalized fibers | | | |
| B2-2 | nonwoven fabric | 0.31 | 0.13 | 42 |
| | having only externally | | | |
| | functionalized fibers | | | |
| B2-3 | nonwoven fabric, | 0.29 | 0.08 | 28 |
| | surface-functionalized | | | |
| | by AS grafting | | | |
| B2-4 | nonwoven fabric, | 0.32 | 0.10 | 31 |
| | surface-functionalized | | | |
| | by sulfonation in | | | |
| | aqueous phase | | | |
| B2-5 | nonwoven fabric, | 0.15 | 0.04 | 27 |
| | surface-functionalized | | | |
| | by sulfonation in gas | | | |
| | phase | | | |

C) Results obtained for analysis of the self-discharging of batteries:

The nonwoven fabrics manufactured in B) were installed as separators in batteries and tested to determine their effect on self-discharging (SE). Five nickel-metal-hydride AA size cells having a capacitance of 1600 mAh and containing separators in accordance with B1-1, B1-4, respectively comparative example B2-1 were manufactured. The self-discharging (SE) was measured in % under different conditions; in this context, the self-discharging indicates the lost charge in %.

Table 2 shows an overview of the results. In the table, d denotes days. The temperature documents the storage temperature of the batteries.

TABLE 2

| | Ammonia | | | |
|---|---|---|---|---|
| | Binding | SE (%) | SE (%) | SE (%) |
| Separator | (mmol/g) | (28 d; 20° C.) | (7 d; 45° C.) | (3 d; 60° C.) |
| B2-1 | 0 | 28-30 | 33-36 | 60-65 |
| B1-1 | 0.38 | 17 | 21 | 42 |
| B1-4 | 0.55 | 16 | 19 | 27 |

The following experiment was performed to verify the effect of the ammonia binding in accordance with the present invention:

A polyolefin that had been functionalized by chemical grafting of acrylic acid onto the same, was ground and divided into two different size fractions.

Fraction 1 exhibited particle sizes of between 400 and 500 μm; fraction 2, particle sizes of between 150 and 250 μm. The ammonia-binding capacity was determined for both fractions.

It became apparent that, in both cases, the binding capacity was (0.55+/−0.05) mmol/g, although the surface of both fractions differed by more than one order of magnitude. Therefore, the binding of the ammonia may not or may not exclusively be a surface effect, but rather (preferably) a depth effect.

Finally, it is especially emphasized that the above exemplary embodiments, selected entirely arbitrarily, are merely intended for purposes of discussing the teaching of the present invention, but not for limiting it to such exemplary embodiments.

1. A layer comprising:
fibers having at least one first substance capable of a chemical and/or physical binding of ammonia or ammonia compounds,
the first substance being present in volumetric regions of the fibers whose surface areas are at least partially covered by a second substance.

2. The layer as recited in claim 1, wherein the volumetric regions are formed as cores and the fibers are formed as core-sheath fibers.

3. The layer as recited in claim 1, wherein at least 80% of the volumetric region is covered by a second substance.

4. The layer as recited in claim 1, wherein the fibers have a weight proportion of at least 30% of the layer.

5. The layer as recited in claim 1, wherein the first substance includes a first polymer, and the second substance includes a second polymer that differs from the first.

6. The layer as recited in claim 5, wherein the first polymer includes a polymer formed by copolymerization.

7. The layer as recited in claim 5, wherein the first polymer includes a polymer formed by grafting.

8. The layer as recited in claim 5, wherein the first polymer includes a polymer that is formed by reactive extrusion.

9. The layer as recited in claim 5, wherein the first polymer includes polyolefin.

10. The layer as recited in claim 7, wherein the first polymer includes polyolefin which is modified by unsaturated organic acids or acid derivatives.

11. The layer as recited in claim 9, wherein the first polymer includes a sulfonated polyolefin.

12. The layer as recited in claim 5, wherein a boundary layer is formed between the first polymer and the second polymer that differs from the first.

13. The layer as recited in claim 1, wherein the layer has an ammonia-binding capacity of at least 0.1 mmol/g.

14. The layer as recited in claim 1, wherein the layer has an ammonia-binding capacity of at least 0.25 mmol/g.

15. The layer as recited in claim 1, wherein, following storage for several days in a hot 30% potassium hydroxide solution, the ammonia-binding capacity of the layer is at least 50% of the initial value.

16. The layer as recited in claim 1, wherein, other second fibers that differ from the fibers are provided that are hydrolytically stable in concentrated alkaline solution.

17. The layer as recited in claim 1, wherein the layer has hydrophilic surfaces.

18. The layer as recited in claim 17, wherein the layer undergoes a fluorination treatment.

19. The layer as recited in claim 17, wherein the layer undergoes a plasma treatment.

20. The layer as recited in claim 17, wherein the layer undergoes a sulfonation treatment.

21. The layer as recited in claim 17, wherein the layer is grafted with polar, unsaturated organic substances.

22. The layer as recited in claim 17, wherein the layer undergoes hydrophilization using a wetting agent.

23. The layer as recited in claim 1, wherein the layer has a substance weight of 15 to 300 g/m².

24. The layer as recited in claim 1, wherein the layer has a substance weight of 25-150 g/m².

25. The layer as recited in claim 1, wherein the layer has a thickness of 20 to 400 μm.

26. The layer as recited in claim 1, wherein the layer has a thickness of 40 to 250 μm.

27. The layer as recited in claim 1, wherein the layer is a nonwoven fabric.

28. The layer as recited in claim 27, wherein the nonwoven fabric is fabricated using a wet-laid nonwoven technology.

29. The layer as recited in claim 27, wherein the nonwoven fabric is fabricated using a dry-laid nonwoven technology.

30. The layer as recited in claim 27, wherein the nonwoven fabric is fabricated using a spunbond nonwoven technology.

31. The layer as recited in claim 27, wherein the nonwoven fabric is fabricated using a meltblown nonwoven technology.

32. A separator in a galvanic cell comprising:
fibers having at least one first substance which renders possible the chemical and/or physical binding of ammonia or ammonia compounds,
wherein the first substance is present in volumetric regions of the fibers whose surface areas are at least partially covered by a second substance.

33. A galvanic cell comprising:
a casing, the casing at least partially accommodating at least one positive and one negative electrode;
a material that permits the transport of charge carriers;
a separator separating the electrodes, wherein the separator includes a layer in accordance with claim 1.

34. A battery comprising the galvanic cell as recited in claim 33.
